(19) United States
(12) Patent Application Publication
(10) Pub. No.: US 2026/0167025 A1
(43) Pub. Date: Jun. 18, 2026

(54) AUTOMATIC GUN-LOCKING STRUCTURE AND CHARGING CONVERTER

(71) Applicant: Dongguan Lanxin Charging Technology Co., Ltd., Dongguan (CN)

(72) Inventor: JINHUA HUANG, Jiujiang (CN)

(21) Appl. No.: 19/006,812

(22) Filed: Dec. 31, 2024

(30) Foreign Application Priority Data
Dec. 18, 2024 (CN) 202423122914.3

(51) Int. Cl. B60L 53/16; B60L 53/35

(52) U.S. Cl. CPC B60L 53/16; B60L 53/35

(57) ABSTRACT

The invention discloses an automatic gun-locking structure comprising a gun-locking slide block, a sliding member, and a return spring; and a charging converter, wherein the gun-locking slide block and the sliding member are respectively slidably installed on a converter body, the sliding member is provided with a straight rod part; a rear end part of the sliding member is provided with a slide block driving part, and the gun-locking slide block is movably installed on the slide block driving part of the sliding member; when in use, the sliding member drives, through the slide block driving part, the gun-locking slide block to be close to or away from a first cavity. The automatic gun-locking structure has advantages of being novel in design, simple in structure, and convenient to use and operate; correspondingly, direct current charging and alternating current charging can be realized, that is, a two-in-one function is provided.

### CROSS-REFERENCE TO RELATED APPLICATIONS

This is a U. S. patent application which claims the priority and benefit of Chinese Patent Application Number 202423122914.3, filed on December 18, 2024, the disclosure of which is incorporated herein by reference in its entirety.

### TECHNICAL FIELD

The present invention relates to the technical field of new energy vehicle charging devices, in particular to an automatic gun-locking structure and a charging converter.

### BACKGROUND

The prior art discloses the following technical solutions, specifically: a charging conversion adapter, comprising a main body, one end of the main body is provided with a first cavity connected to a charging gun on a charging pile, one end of the main body away from the first cavity is provided with two second cavities, and the second cavities are connected to a charging head of a storage battery on a new energy vehicle; an adjustment cavity is provided at one end of the main body close to the first cavity, and a resisting block is slidably installed in a first sliding hole communicating the adjustment cavity and the first cavity, and two end parts of the resisting block respectively extend into the adjustment cavity and the first cavity on the corresponding sides; an adjustment mechanism is provided on the main body, the adjustment mechanism includes a first spring, the first spring is in contact with the resisting block, and when the charging gun enters the first cavity, the charging gun will resist-contact the resisting block and compress the first spring; two second sliding holes in communication with the adjustment cavity are provided at one end of the main body close to the second cavity, an adjusting assembly is provided on the main body, the adjusting assembly includes an adjusting rod, an adjusting plate and a pushing rod which are connected in sequence, and an adjusting block slidably installed in the adjusting cavity, the pushing rod is sleeved with a second spring, moreover the adjusting block is connected to the pushing rod, and a limiting block is provided on the adjusting block; the adjusting block is also provided with a reset assembly, the reset assembly includes a connecting block integrally arranged with the adjusting block, and a reset block is fixedly connected to one end of the connecting block away from the adjusting block.

When the above-mentioned charging conversion adapter is used, while the main body is not connected to the charging head on the new energy vehicle, the second spring is in an extended state and the adjusting rod extends toward a side away from the adjusting block; when the charging gun is located in the first cavity of the main body, and when the resisting block remains tightly resisting the charging gun, the main body is connected to the charging head on the new energy vehicle, when the main body is connected to the charging head, the adjusting rod will resist-contact a vehicle body of the new energy vehicle, at this time, the adjusting assembly moves and the second spring is compressed, the adjusting block drives the limiting block to move in a direction close to the tight resisting block, and finally makes the limiting block resist-contact with the resisting block, and at this time, the resisting block locks the charging gun; after charging is completed, the main body or the charging gun is pulled, to make the main body to be separated from the charging head, then the reset block is moved, the reset block drives the connecting block to move, and the connecting block drives the adjusting block to move in a direction away from a lifting block, to make the limiting block on the adjusting block to be separated from the resisting block; finally, the charging gun is pulled out, to make the charging gun to be separated from the first cavity on the main body.

It needs to be pointed out that the above-mentioned charging conversion adapter has the following defects, specifically: the resisting block, the first spring, the adjusting rod, the adjusting plate, the adjusting block, the limiting block, the second spring, the connecting block, and the reset block together form a gun-locking structure. When locking the charging gun, the adjusting rod, the adjusting plate, the adjusting block and the limiting block move toward a side of the resisting block, and make the limiting block resist-contact and limit the resisting block, so as to make the resisting block lock the charging gun in the first cavity; after charging is completed, the reset block and the connecting block are moved and operated and the adjusting block is reset, thereby eliminating the limiting effect of the limiting block, and at this time, locking of the charging gun is released. The overall structure of the above-mentioned gun-locking structure is complex, and manual operation is needed to move the reset block. Since automatic reset cannot be achieved, the convenience in use and operation is poor.

### SUMMARY

One objective of the present invention is to provide an automatic gun-locking structure in view of the shortcomings of the prior art. The automatic gun-locking structure is novel in design, simple in structure, and convenient to use and operate.

Another objective of the present invention is to provide a charging converter in view of the shortcomings of the prior art. The charging converter is novel in design, simple in structure, and convenient to use and operate.

In order to achieve the foregoing objectives, the present invention is achieved through the following technical solutions.

An automatic gun-locking structure, wherein the automatic gun-locking structure is applied to a charging converter, the charging converter comprises a converter body, the converter body is provided with a first cavity for inserting a charging gun, and a second cavity for inserting a vehicle charging stand of a new energy vehicle, the first cavity is located at a rear end part of the converter body, and the second cavity is located at a front end part of the converter body; the automatic gun-locking structure comprises a gun-locking slide block, a sliding member, and a return spring that elastically pushes the sliding member toward a second cavity side, the gun-locking slide block and the sliding member are respectively slidably installed on the converter body, a sliding direction of the gun-locking slide block is perpendicular to that of the sliding member, and the sliding member is provided with a straight rod part extending into the second cavity; a rear end part of the sliding member is provided with a slide block driving part, and the gun-locking slide block is movably installed on the slide block driving part of the sliding member; when the sliding member moves backward relative to the converter body, the sliding member drives, through the slide block driving part, the gun-locking slide block to move toward a first cavity side; and when the sliding member moves forward relative to the converter body, the sliding member drives, through the slide block driving part, the gun-locking slide block to move away from the first cavity side.

Therein, the gun-locking slide block is provided with an inclined hole corresponding to the sliding member, the slide block driving part is provided with an inclined segment, and the inclined segment of the slide block driving part is slidably embedded into the inclined hole of the gun-locking slide block.

Therein, the converter body is provided with a gun-locking auxiliary block, and the sliding member comprises a base located between the slide block driving part and the straight rod part; The base of the sliding member is slidably installed on the gun-locking auxiliary block, the return spring is installed between the gun-locking auxiliary block and the base of the sliding member, a front end part of the return spring abuts against the base of the sliding member, and a rear end part of the return spring abuts against the gun-locking auxiliary block.

Therein, the gun-locking auxiliary block is provided with an auxiliary block through hole for the gun-locking slide block to pass through, and the converter body is provided with a body through hole in communication with the first cavity and aligned with the auxiliary block through hole; when the charging gun is inserted into the first cavity in place, a lock groove of the charging gun is aligned with the body through hole.

Therein, the gun-locking auxiliary block is provided with a chute corresponding to the sliding member, and the base of the sliding member is slidably installed in the chute of the gun-locking auxiliary block;

A side wall of the chute is provided with a guide groove corresponding to the sliding member, the base of the sliding member is provided with a guide column corresponding to the guide groove, and the guide column of the sliding member extends into the guide groove.

Therein, the gun-locking auxiliary block is provided with a spring positioning cavity on a side of the chute, and the spring positioning cavity is in communication with the chute; the return spring is positioned and installed in the spring positioning cavity, the base of the sliding member is provided with a convex part extending into the spring positioning cavity, and the front end part of the return spring abuts against the convex part.

Therein, the converter body is provided with a guide hole in communication with the second cavity corresponding to the straight rod part of the sliding member, and the straight rod part of the sliding member passes through the guide hole of the converter body.

A charging converter, which comprises the above-mentioned automatic gun-locking structure.

Therein, the converter body comprises a body shell, the first cavity is provided at a front end part of the body shell, and the second cavity is provided at a rear end part of the body shell; an insulating bracket is tightly installed inside the body shell, a terminal assembly is tightly installed on the insulating bracket, the terminal assembly comprises a direct current DC+ terminal, a direct current DC- terminal, an alternating current L1 terminal, and an alternating current N terminal, the direct current DC+ terminal and the DC- terminal are arranged at intervals, a front end part of the direct current DC+ terminal and a front end part of the direct current DC- terminal respectively extend into the first cavity, and a rear end part of the direct current DC+ terminal and a rear end part of the direct current DC- terminal respectively extend into the second cavity; the alternating current N terminal and the direct current DC+ terminal are tightly connected and the alternating current N terminal and the direct current DC+ terminal are electrically connected in series, and the alternating current L1 terminal and the direct current DC- terminal are tightly connected and the alternating current L1 terminal and the direct current DC- terminal are electrically connected in series.

Therein, the converter body is provided with a charging switching button.

Compared with the prior art, the present invention has the following beneficial effects, specifically:

1, the automatic gun-locking structure of the present invention comprises a sliding member, a return spring and a gun-locking slide block, and the sliding member and the gun-locking slide block link with each other. compared with the prior art, the overall structure of the automatic gun-locking structure of the present invention is simpler;

2, when the automatic locking gun structure of the invention is in operation, when the converter body is removed from a vehicle charging stand of a new energy vehicle, the sliding member automatically resets and moves toward the second cavity side under the action of reset elastic force of the return spring, thereby making the gun-locking slide block automatically move and retreat from the charging gun; compared with the prior art, the automatic gun-locking structure of the present invention is more convenient to operate and use;

3, the automatic gun-locking structure of the present invention has the advantages of being novel in design, simple in structure, and convenient to use and operate; correspondingly, the charging converter comprising the automatic gun-locking structure also has the advantages of being novel in design, simple in structure, and convenient to use and operate.

### BRIEF DESCRIPTION OF DRAWINGS

The present invention will be further described below using the accompanying drawings, but the embodiments in the accompanying drawings do not constitute any limitation on the present invention.

FIG. 1 is a structural schematic diagram of the present invention.

FIG. 2 is a structural schematic diagram of the present invention from another angle of view.

FIG. 3 is a cross-sectional schematic diagram of the present invention when locking a charging gun.

FIG. 4 is a cross-sectional schematic diagram of the present invention when unlocking the charging gun.

FIG. 5 is a structural schematic diagram of an automatic gun-locking assembly of the present invention.

FIG. 6 is a structural schematic diagram of the automatic gun-locking assembly of the present invention from another angle of view.

FIG. 7 is a structural schematic diagram of a terminal assembly of the present invention.

FIG. 8 is an exploded schematic diagram of the terminal assembly of the present invention.

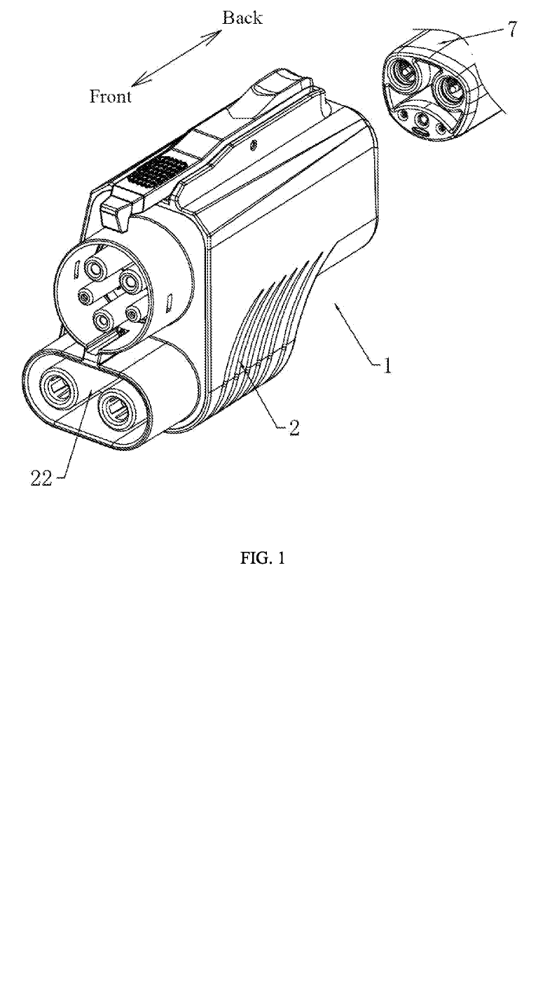

FIG. 1 to FIG. 8 include:

1-Charging converter; 2-Converter body; 21-First cavity; 22-Second cavity; 23-Body through hole; 24-Guide hole; 3-Gun-locking slide block; 31-Inclined hole; 4-Sliding member; 41-Straight rod part; 42-Slide block driving part; 421-Inclined segment; 43-Base; 431-Guide column; 432-Convex part; 5-Return spring; 6-Gun-locking auxiliary block; 61-Auxiliary block through hole; 62-Chute; 63-Guide groove; 64-Spring positioning cavity; 7-Charging gun; 71-Lock groove; 8-Charging switching button; 91-Insulating bracket; 921-Direct current DC+ terminal; 922-Direct current DC- terminal; 923-Alternating current L1 terminal; 924-Alternating current N terminal.

### DESCRIPTION OF EMBODIMENTS

The present invention will be explained below in conjunction with the specific embodiments.

Embodiment I. FIGS. 1 to 4 show an automatic gun-locking structure, wherein the automatic gun-locking structure is applied to a charging converter 1. The charging converter 1 comprises a converter body 2, the converter body 2 is provided with a first cavity 21 for inserting a charging gun 7, and a second cavity 22 for inserting a vehicle charging stand of a new energy vehicle, the first cavity 21 is located at a rear end part of the converter body 2, and the second cavity 22 is located at a front end part of the converter body 2.

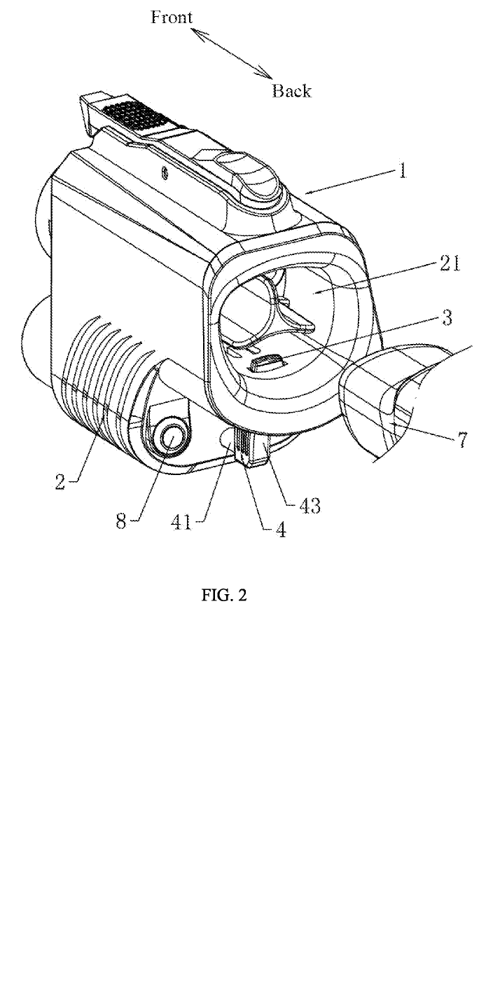

Therein, as shown in FIGS. 2 to 6, the automatic gun-locking structure comprises a gun-locking slide block 3, a sliding member 4, a return spring 5 that elastically pushes the sliding member 4 toward a second cavity 22 side, and the gun-locking slide block 3 and the sliding member 4 are respectively slidably installed on the converter body 2, a sliding direction of the gun-locking slide block 3 is perpendicular to that of the sliding member 4, and the sliding member 4 is provided with a straight rod part 41 extending into the second cavity 22.

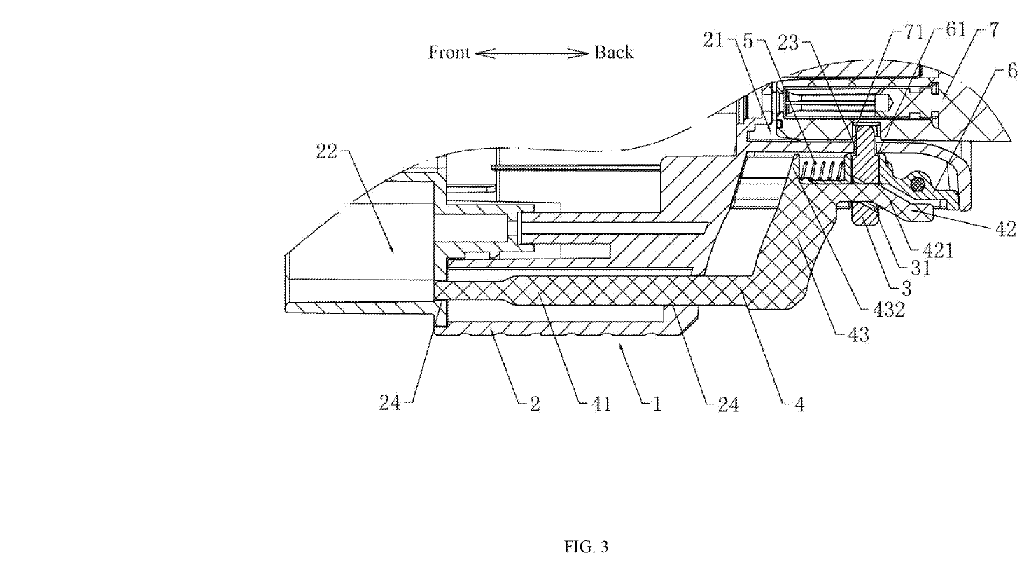

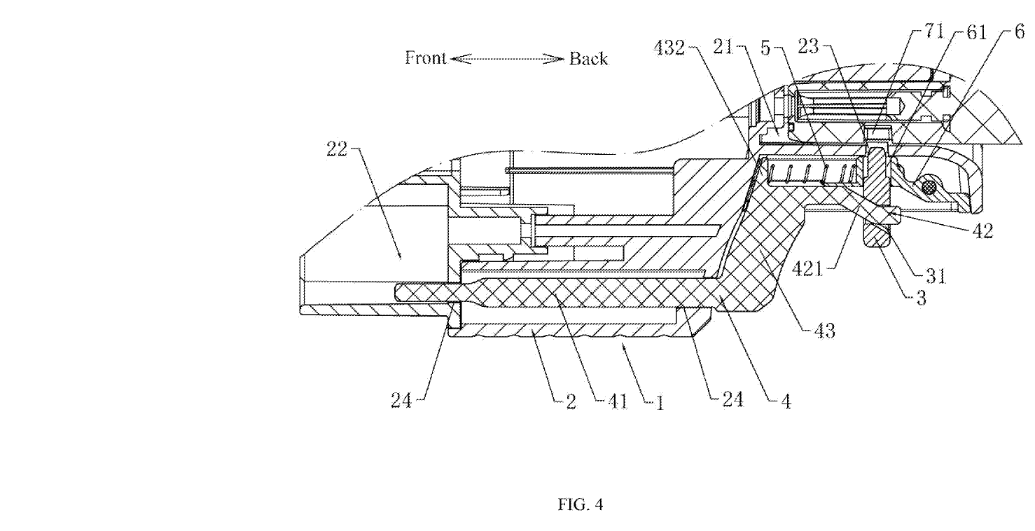

Further, as shown in FIGS. 3 and 4, a rear end part of the sliding member 4 is provided with a slide block driving part 42, and the gun-locking slide block 3 is movably installed on the slide block driving part 42 of the sliding member 4; when the sliding member 4 moves backward relative to the converter body 2, the sliding member 4 drives, through the slide block driving part 42, the gun-locking slide block 3 to move toward a first cavity 21 side; when the sliding member 4 moves forward relative to the converter body 2, the sliding member 4 drives, through the slide block driving part 42, the gun-locking slide block 3 to move away from the first cavity 21 side.

Specifically, as shown in FIGS. 3 and 4, the gun-locking slide block 3 is provided with an inclined hole 31 corresponding to the sliding member 4, the slide block driving part 42 is provided with an inclined segment 421, and the inclined segment 421 of the slide block driving part 42 is slidably embedded in the inclined hole 31 of the gun-locking slide block 3. When the sliding member 4 slides forward and backward relative to the converter body 2, the inclined segment 421 of the slide block driving part 42 of the sliding member 4 is matched with the inclined hole 31 of the gun-locking slide block 3, and the inclined segment 421 of the slide block driving part 42 drives the gun-locking slide block 3 to move relatively close to or away from the first cavity 21.

Taking an NACS standard charging gun 7 and an American standard CCS1 standard vehicle charging stand of a new energy vehicle as an example, the automatic gun-locking structure of the present embodiment I is described in detail below. Specifically: during charging operation, first the NACS standard charging gun 7 is inserted into the first cavity 21 of the converter body 2, when the NACS standard charging gun 7 is inserted in place, a locking groove 71 of the NACS standard charging gun 7 is aligned with the gun-locking slide block 3, and at this time, the straight rod part 41 of the sliding member 4 extends into the second cavity 22 and the return spring 5 is in an extended state; after the NACS standard charging gun 7 is inserted into the first cavity 21 and is in place, the second cavity 22 of the converter body 2 is aligned with the American standard CCS1 standard vehicle charging stand, and the American CCS1 standard vehicle charging stand is inserted into the second cavity 22 of the converter body 2, in this process, the American standard CCS1 standard vehicle charging stand will press against the straight rod part 41 of the sliding member 4 toward a first cavity 21 side and make the sliding member 4 move toward the first cavity 21 side, as the sliding member 4 moves backward, the return spring 5 is compressed, and the sliding member 4 drives, through the slide block driving part 42, the gun-locking slide block 3 to move toward the first cavity 21 side, and finally makes the gun-locking slide block 3 be inserted into the locking groove 71 of the NACS standard charging gun 7, so as to achieve that the NACS standard charging gun 7 is locked and fixed in the first cavity 21 of the converter body 2; when charging is completed and the NACS standard charging gun 7 is unlocked, since the gun-locking slide block 3 locks the NACS standard charging gun 7, the converter body 2 and the NACS standard charging gun 7 move synchronously and retreat away from the American standard CCS1 standard vehicle charging stand of the new energy vehicle.

In this process, the action of return elastic force of the return spring 5 makes the sliding member 4 move toward the second cavity 22 side, and the straight rod part 41 of the sliding member 4 re-enters the second cavity 22, as the sliding member 4 moves forward relative to the converter body 2, the slide block driving part 42 of the sliding member 4 drives the gun-locking slide block 3 to move away from the first cavity 21 side, and makes the gun-locking slide block 3 gradually withdraw from the locking groove 71 of the NACS standard charging gun 7, when the gun-locking slide block 3 completely withdraws from the lock groove 71 of the NACS standard charging gun 7, the locking action of the gun-locking slide block 3 on the NACS standard charging gun 7 is released, the NACS standard charging gun 7 can be pulled out of the first cavity 21 of the converter body 2, and thus risk of live disconnection of the gun during high-voltage charging can be effectively avoided.

It needs to be emphasized that the automatic gun-locking structure of the present embodiment I comprises the sliding member 4, the return spring 5 and the gun-locking slide block 3, and the sliding member 4 and the gun-locking slide block 3 link with each other; compared with the prior art, the overall structure of the automatic gun-locking structure of the present embodiment I is simpler.

In addition, when the converter body 2 is removed from the vehicle charging stand of the new energy vehicle, the sliding member 4 automatically returns and moves toward a second cavity 22 side under the action of return elastic force of the return spring 5, and then makes the gun-locking slide block 3 automatically move and retreat from the charging gun 7; compared with the prior art, the automatic gun-locking structure of the present embodiment I is more convenient to operate and use.

Based on the above situation, it can be seen that through the above structural design, the automatic gun-locking structure of the present embodiment I has the advantages of being novel in design, simple in structure, and convenient to use and operate.

Embodiment II, as shown in FIGS. 3 to 6, the difference between the present embodiment II and Embodiment I is that the converter body 2 is provided with a gun-locking auxiliary block 6, and the sliding member 4 comprises a base 43 located between the slide block driving part 42 and the straight rod part 41.

Therein, the base 43 of the sliding member 4 is slidably installed on the gun-locking auxiliary block 6, the return spring 5 is installed between the gun-locking auxiliary block 6 and the base 43 of the sliding member 4, a front end part of the return spring 5 abuts against the base 43 of the sliding member 4, and a rear end part of the return spring 5 abuts against the gun-locking auxiliary block 6.

Embodiment III. As shown in FIGS. 3 and 4, the difference between the present embodiment III and Embodiment II is that the gun-locking auxiliary block 6 is provided with an auxiliary block through hole 61 for the gun-locking slide block 3 to pass through, and the converter body 2 is provided with a body through hole 23 in communication with the first cavity 21 and aligned with the auxiliary block through hole 61; when the charging gun 7 is inserted into the first cavity 21 in place, the locking groove 71 of the charging gun 7 is aligned with the body through hole 23.

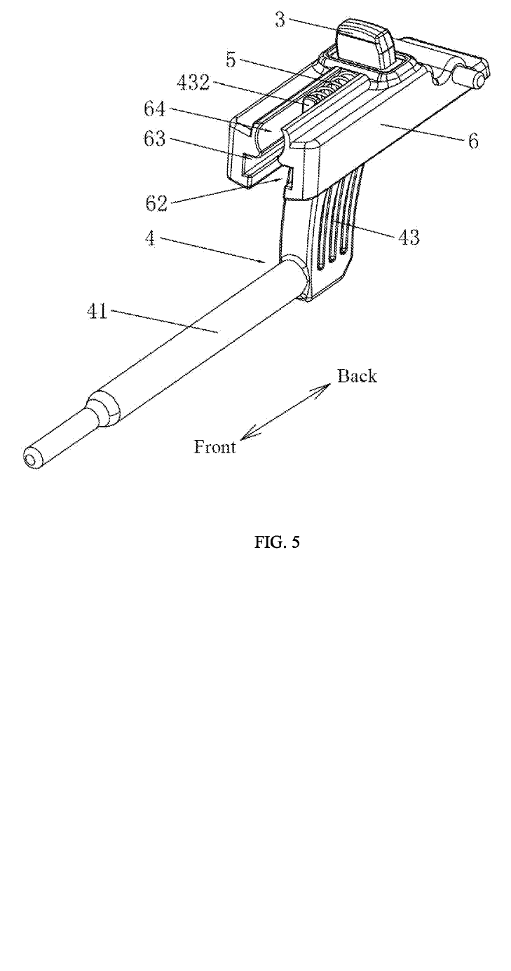

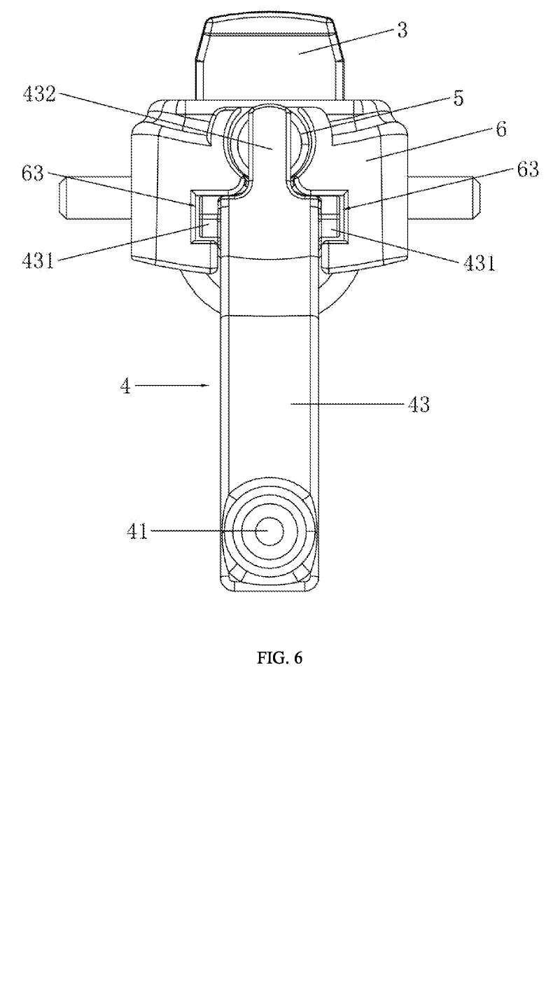

Embodiment IV. As shown in FIGS. 5 and 6, the difference between the present embodiment IV and Embodiment II is that the gun-locking auxiliary block 6 is provided with a chute 62 corresponding to the sliding member 4, and the base 43 of the sliding member 4 is slidably installed in the chute 62 of the gun-locking auxiliary block 6.

Therein, a side wall of the chute 62 is provided with a guide groove 63 corresponding to the sliding member 4, the base 43 of the sliding member 4 is provided with a guide column 431 corresponding to the guide groove 63, and the guide column 431 of the sliding member 4 extends into the guide groove 63.

In a process that the sliding member 4 makes forward and backward sliding movements relative to the converter body 2, in the present embodiment IV, through the coordination between the guide groove 63 of the gun-locking auxiliary block 6 and the guide column 431 of the sliding member 4, the sliding member 4 is guided to accurately move, so as to improve the stability of the sliding movements of the sliding member 4.

Embodiment V. As shown in FIGS. 5 and 6, the difference between the present embodiment V and Embodiment IV is that the gun-locking auxiliary block 6 is provided with a spring positioning cavity 64 on a side of the chute 62, and the spring positioning cavity 64 is in communication with the chute 62.

Therein, the return spring 5 is positioned and installed in the spring positioning cavity 64, the base 43 of the sliding member 4 is provided with a convex part 432 that extends into the spring positioning cavity 64, and a front end part of the return spring 5 abuts against the convex part 432.

In the present embodiment V, the return spring 5 is positioned through the spring positioning cavity 64, on the one hand, the convenience of installation of the return spring 5 can be effectively improved, and on the other hand, the stability of the return spring 5 in work can be effectively improved.

Embodiment VI. As shown in FIGS. 3 and 4, the difference between the present embodiment VI and Embodiment I is that the converter body 2 is provided with a guide hole 24 in communication with the second cavity 22 corresponding to the straight rod part 41 of the sliding member 4, and the straight rod part 41 of the sliding member 4 passes through the guide hole 24 of the converter body 2.

Embodiment VII. As shown in FIGS. 1 to 4, a charging converter comprises the above-mentioned automatic gun-locking structure.

It needs to be pointed out that the above-mentioned automatic gun-locking structure has the advantages of novel design, simple structure, and convenience in use and operation; accordingly, the charging converter 1 of the embodiment VII comprises the charging converter 1 with the automatic gun-locking structure, and also has the advantages of novel design, simple structure, and convenience in use and operation.

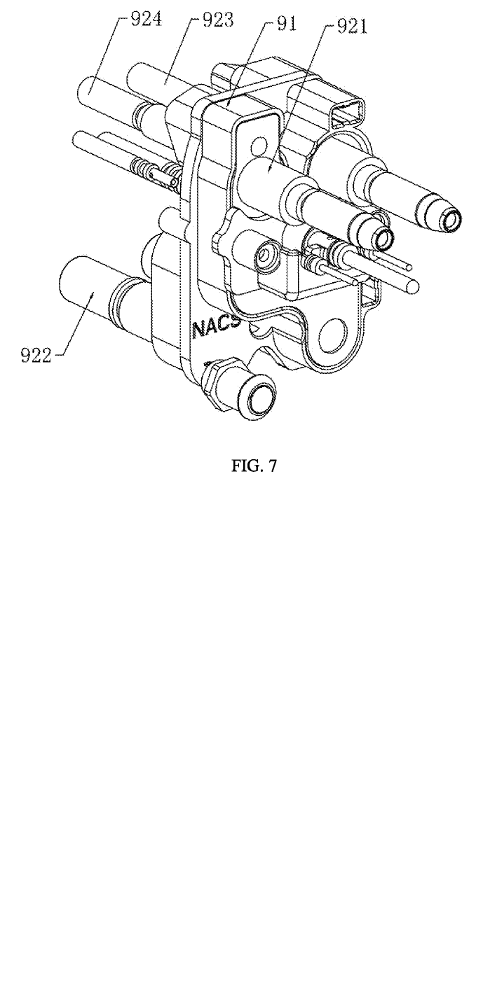

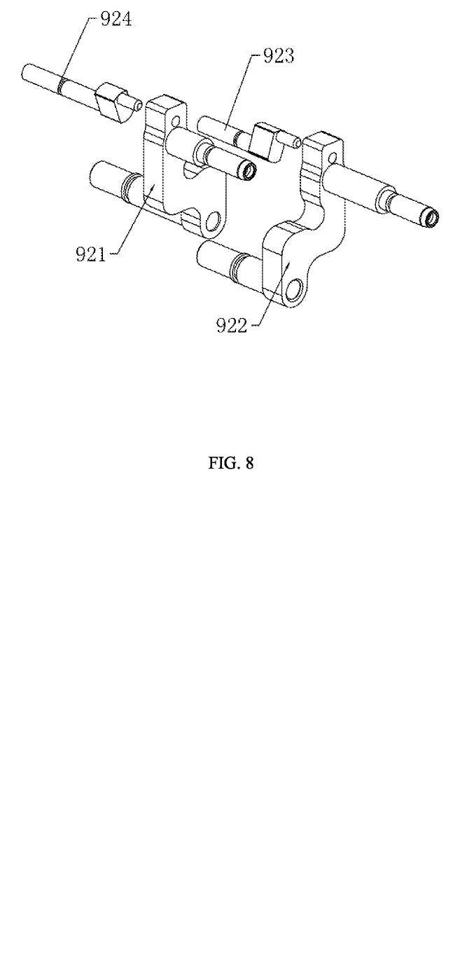

Embodiment VIII. As shown in FIGS. 7 and 8, the difference between the present embodiment VIII and Embodiment VII is that the converter body 2 comprises a body shell, the first cavity 21 is provided at a front end part of the body shell, and the second cavity 22 is provided at a rear end part of the body shell.

Therein, an insulating bracket 91 is tightly installed inside the body shell, a terminal assembly is tightly installed on the insulating bracket 91, the terminal assembly comprises a direct current DC+ terminal 921, a direct current DC- terminal 922, an alternating current L1 terminal 923, and an alternating current N terminal 924, the direct current DC+ terminal 921 and the direct current DC- terminal 922 are arranged at intervals, a front end part of the direct current DC+ terminal 921 and a front end part of the direct current DC- terminal 922 respectively extend into the first cavity 21 and are electrically connected to the charging gun 7 respectively during charging, and a rear end part of the direct current DC+ terminal 921 and a rear end part of the direct current DC- terminal 922 respectively extend into the second cavity 22.

In addition, the alternating current N terminal 924 and the direct current DC+ terminal 921 are tightly connected and the alternating current N terminal 924 and the direct current DC+ terminal 921 are electrically connected in series, and the alternating current L1 terminal 923 and the direct current DC- terminal 922 are tightly connected and the alternating current L1 terminal 923 and the direct current DC- terminal 922 are electrically connected in series.

It needs to be explained that the alternating current N terminal 924 can be tightly installed on the direct current DC+ terminal 921 by riveting, and similarly, the alternating current L1 terminal 923 can be tightly installed on the direct current DC- terminal 922 by riveting.

In addition, the converter body 2 is provided with a charging switching button 8. As for the charging switching button 8 of the present embodiment VIII, its function is: the charging switching button 8 can realize alternating current and direct current charging switching. When the input of the charging gun 7 is AC, the charging switch button 8 can be used to switch to an AC alternating current charging state, at this time, an alternating current signal is input to a vehicle charging stand of a new energy vehicle, and the alternating current L1 terminal 923 and the alternating current N terminal 924 will receive the input of electric energy; when the input of the charging gun 7 is DC, the charging switching button 8 can be used to switch to a DC direct current charging state, at this time, a direct current signal is input to the vehicle charging stand of the new energy vehicle, and the direct current DC+ terminal 921 and the direct current DC- terminal 922 will receive the input of electric energy.

The charging converter of the present embodiment VIII is able to realize alternating current charging and direct current charging, and then can realize a two-in-one function.

The above contents are only the preferred embodiments of the present invention. For those of ordinary skill in the art, there will be changes in the specific implementation modes and application scope according to the ideas of the present invention. The contents of this specification should not be understood as limitations on the scope of the present invention.

What is claimed is:

1. An automatic gun-locking structure, wherein the automatic gun-locking structure is applied to a charging converter (1), the charging converter (1) comprises a converter body (2), the converter body (2) is provided with a first cavity (21) for inserting a charging gun (7) and a second cavity (22) for inserting a vehicle charging stand of a new energy vehicle, the first cavity (21) is located at a rear end part of the converter body (2), and the second cavity (22) is located at a front end part of the converter body (2);
the automatic gun-locking structure comprises a gun-locking slide block (3), a sliding member (4), and a return spring (5) that elastically pushes the sliding member (4) toward a second cavity (22) side, the gun-locking slide block (3) and the sliding member (4) are respectively slidably installed on the converter body (2), a sliding direction of the gun-locking slide block (3) is perpendicular to that of the sliding member (4), and the sliding member (4) is provided with a straight rod part (41) extending into the second cavity (22);
wherein a rear end part of the sliding member (4) is provided with a slide block driving part (42), and the gun-locking slide block (3) is movably installed on the slide block driving part (42) of the sliding member (4);
when the sliding member (4) moves backward relative to the converter body (2), the sliding member (4) drives, through the slide block driving part (42), the gun-locking slide block (3) to move toward a first cavity (21) side; and when the sliding member (4) moves forward relative to the converter body (2), the sliding member (4) drives, through the slide block driving part (42), the gun-locking slide block (3) to move away from the first cavity (21) side.

2. The automatic gun-locking structure according to claim 1, wherein the gun-locking slide block (3) is provided with an inclined hole (31) corresponding to the sliding member (4), and the slide block driving part (42) is provided with an inclined segment (421), and the inclined segment (421) of the slide block driving part (42) is slidably embedded into the inclined hole (31) of the gun-locking slide block (3).

3. The automatic gun-locking structure according to claim 1, wherein the converter body (2) is provided with a gun-locking auxiliary block (6), and the sliding member (4) comprises a base (43) located between the slide block driving part (42) and the straight rod part (41);
the base (43) of the sliding member (4) is slidably installed on the gun-locking auxiliary block (6), the return spring (5) is installed between the gun-locking auxiliary block (6) and the base (43) of the sliding member (4), a front end part of the return spring (5) abuts against the base (43) of the sliding member (4), and a rear end part of the return spring (5) abuts against the gun-locking auxiliary block (6).

4. The automatic gun-locking structure according to claim 3, wherein the gun-locking auxiliary block (6) is provided with an auxiliary block through hole (61) for the gun-locking slide block (3) to pass through, and the converter body (2) is provided with a body through hole (23) that is in communication with the first cavity (21) and aligned with the auxiliary block through hole (61);
when the charging gun (7) is inserted into the first cavity (21) in place, a lock groove (71) of the charging gun (7) is aligned with the body through hole (23).

5. The automatic gun-locking structure according to claim 3, wherein the gun-locking auxiliary block (6) is provided with a chute (62) corresponding to the sliding member (4), and the base (43) of the sliding member (4) is slidably installed in the chute (62) of the gun-locking auxiliary block (6);
a side wall of the chute (62) is provided with a guide groove (63) corresponding to the sliding member (4), the base (43) of the sliding member (4) is provided with a guide column (431) corresponding to the guide groove (63), and the guide column (431) of the sliding member (4) extends into the guide groove (63).

6. The automatic gun-locking structure according to claim 5, wherein the gun-locking auxiliary block (6) is provided with a spring positioning cavity (64) on a side of the chute (62), and the spring positioning cavity (64) is in communication with the chute (62);
the return spring (5) is positioned and installed in the spring positioning cavity (64), the base (43) of the sliding member (4) is provided with a convex part (432) that extends into the spring positioning cavity (64), and the front end part of the return spring (5) abuts against the convex part (432).

7. The automatic gun-locking structure according to claim 1, wherein the converter body (2) is provided with a guide hole (24) that is in communication with the second cavity (22) corresponding to the straight rod part (41) of the sliding member (4), and the straight rod part (41) of the sliding member (4) passes through the guide hole (24) of the converter body (2).

8. A charging converter, comprising the automatic gun-locking structure according to claim 1.

9. The charging converter according to claim 8, wherein the converter body (2) comprises a body shell, the first cavity (21) is provided at a front end part of the body shell, and the second cavity (22) is provided at a rear end part of the body shell;
an insulating bracket (91) is tightly installed inside the body shell, a terminal assembly is tightly installed on the insulating bracket (91), the terminal assembly comprises a direct current DC+ terminal (921), a direct current DC- terminal (922), an alternating current L1 terminal (923), and an alternating current N terminal (924), the direct current DC+ terminal (921) and the direct current DC- terminal (922) are arranged at intervals, a front end part of the direct current DC+ terminal (921) and a front end part of the direct current DC- terminal (922) respectively extend into the first cavity (21), and a rear end part of the direct current DC+ terminal (921) and a rear end part of the direct current DC- terminal (922) respectively extend into the second cavity (22);
the alternating current N terminal (924) and the direct current DC+ terminal (921) are tightly connected and the alternating current N terminal (924) and the direct current DC+ terminal (921) are electrically connected in series, and the alternating current L1 terminal (923) and the direct current DC- terminal (922) are tightly connected and the alternating current L1 terminal (923) and the direct current DC- terminal (922) are electrically connected in series.

10. The charging converter according to claim 9, wherein the converter body (2) is provided with a charging switching button (8).
